(19) United States
(12) Patent Application Publication
(10) Pub. No.: US 2024/0291363 A1
(43) Pub. Date: Aug. 29, 2024

(54) ELECTRIC MOTOR COIL WINDER

(71) Applicant: SNT MOTIV CO., LTD., Busan (KR)

(72) Inventor: Jong Hyun BYUN, Busan (KR)

(73) Assignee: SNT MOTIV CO., LTD., Busan (KR)

(21) Appl. No.: 18/571,255

(22) PCT Filed: Jun. 30, 2021
(86) PCT No.: PCT/KR2021/008237

§ 371 Date: Dec. 18, 2023

(30) Foreign Application Priority Data
Jun. 16, 2021 (KR) 10-2021-0077831

(51) Int. Cl. H02K 15/085

(52) U.S. Cl. CPC H02K 15/085; H02K 2215/00

(57) ABSTRACT

An electric motor coil winder is provided. A cutting length of a wire used for an electric motor coil is controlled according to the location of a slot formed at a stator inside an electric motor so that a wasted wire can be reduced and a manufacturing cost and energy thus can be reduced, a cutting cover is installed at a cutting part to prevent a cut wire from popping up and protect the inside of the cutting part, and the length of a wire required for a process is set to enhance production efficiency.

### CROSS REFERENCE TO THE RELATED APPLICATIONS

This application is the national phase entry of International Application No. PCT/KR2021/008237, filed on Jun. 30, 2021, which is based upon and claims priority to Korean Patent Application No. 10-2021-0077831, filed on Jun. 16, 2021, the entire contents of which are incorporated herein by reference.

### TECHNICAL FIELD

The present disclosure relates to an electric motor coil winder and, more particularly, to an electric motor coil winder capable of controlling a cutting length of a wire used in an electric motor coil according to a position of a slot provided in a stator inside the motor to save the wire from being wasted, thereby reducing manufacturing costs and energy. Furthermore, the coil winder may be provided with a cutting cover installed on a cutting part to prevent the wire that is cut from popping up, thereby protecting the interior, and may be set with the length of the wire required for the coil winding process to improve production efficiency.

### BACKGROUND

An electric motor is a device that converts electrical energy by utilizing force that a current-carrying conductor receives in a magnetic field into mechanical energy and is generally referred to as a motor.

Here, electric motors are classified into direct current motors and alternating current motors depending on the type of power supplied, and alternating current motors are further divided into three-pulse alternating current and single-pulse alternating current motors. Today, three-pulse alternating current motors are mainly used.

In addition, methods of winding a coil on a stator inside the electric motor include a method of directly winding the coil on the stator and a method of winding the coil first in a certain shape and inserting it into slots provided between the teeth that are provided on an inner wall of the stator. Generally, a motor with higher performance requires more strands of coils to be wound on it.

In addition, the slots, which are grooves made in an iron core to insert the coil inside the electric motor, are arranged in a circle around a rotating shaft, and the arrangement of the coil inserted in the slots varies according to pulses of the supplied power, poles of the motor, and the winding method.

At this time, the position of an output terminal that receives power from the motor is limited to one side of the motor, so the distance from a lead wire extending from the coil is different depending on the position of the slot, and, in coil connection and manufacturing the lead wire for the same pulse, there is a loss of material because the wire cut to fit the length was wasted.

Accordingly, Republic of Korea Patent No. 10-0368762 “DEVICE FOR GRIPPING AND CUTTING COIL OF COIL WINDING MACHINE” discloses a technology that controls an operating arm unit to flexibly adapt to a coil length according to product characteristics, thereby reducing material costs and labor. However, the length of a wire required according to the pulse of the electric motor has not been taken into consideration. In addition, there are some difficult aspects to respond to a phenomenon that several strands of the coil are cut and popping up outwards and to production stoppages that occur due to a lack of wire during coil winding.

In addition, in Republic of Korea Patent No. 10-1891039, in order to prevent a phenomenon that several coils are cut and popping up outwards, a technology has been proposed to protect a winder by preventing the windings from spreading or scattering by taping the coils into a bundle. However, there are costs associated with the additional installation of taping machines and challenges in applying them within limited environments, such as the confined space of the winder. Furthermore, there are remaining difficulties in reducing the costs of wire materials for manufacturing motor coils.

Therefore, there is a need for an electric motor coil winder that reduces material costs by respectively tailoring a required wire length according to the pulse of the electric motor coil, prevents the cut wire from being scattered so as not to damage the winder, while still being configured for easy application to existing machines, and prevents work from being interrupted due to the lack of the wire during the process.

### SUMMARY

### Technical Problem

Accordingly, the present disclosure has been made keeping in mind the above problems occurring in the related art, and an objective of the present disclosure is to provide a coil winder that may reduce material costs and energy by respectively tailoring required wire lengths according to pulses in manufacturing an electric motor coil.

In addition, another objective of the present disclosure is to provide the coil winder that is prevented from being damaged by a cut wire, while still being configured for easy application to existing machines.

Furthermore, still another objective of the present disclosure is to provide the coil winder that prevents work from being interrupted due to a lack of a wire supplied during the process of manufacturing the electric motor coil.

The objectives of the present disclosure are not limited to the objectives mentioned above, and other objectives not mentioned will be clearly understood by those skilled in the art from the description below.

### Technical Solution

In order to accomplish the above objective, the present disclosure may provide an electric motor coil winder 100 that minimizes a loss of a wire W required to manufacture a coil of an electric motor, the coil winder including: a rotary table 10 provided with an insert tool 11 on which the coil is to be stacked on an upper surface and a rotation motor 12 configured to rotate the insert tool 11; a winding framework part 20 provided with a winding cylinder 21, which is vertically provided above the rotary table 10, winding guides 22 installed at an end part of a rod of the winding cylinder 21 and around which the wire W is to be wound, and a support part 23 provided on the winding guides 22 and configured to slide up and down so that the coil is stacked on the insert tool 11; a flier part 30 configured to wind the wire W, which is wound around a wire supply part 31, to the winding guides 22, while rotating along an outer part of the winding guides 22; a gripping part 40 configured to hold one side of the wire W and pull and move the wire W to an outside of the winding framework part 20 after the rotating operation of the flier 30; a cutting part 50 provided with a cutting member 51 configured to cut the wire W pulled by the gripping part 40 and a cutting cover 52 configured to protect the coil winder 100 by surrounding the wire W at a predetermined interval to prevent the wire W from popping up outwards when the wire W is cut; and a controller 60 configured to control sequential operations of the coil winder 100 and a moving distance of the gripping part 40.

In addition, the cutting cover 52 may be provided with an insertion groove, in which inclined surfaces each having a predetermined angle are provided to allow the wire W to be slid to a center to be aligned when the cutting part 50 moves perpendicular to a length direction of the wire W, and prevents the wire W from popping up outwards when the wire W is cut by including an anti-reverse movement device 53 that is configured to prevent the wire W positioned inside the insertion groove from moving outwards, thereby preventing damage to the coil winder 100.

In addition, the controller 60 may set a length of a lead wire that is the wire W extending from a slot provided inside the electric motor up to an output terminal but tailor the length of each lead wire according to the pulse of the electric motor, thereby reducing the loss of the wire W that may occur while aligning the lead wire in the output terminal.

Furthermore, the controller 60 may be configured to determine whether the coil winder 100 is suitable for operation by comparing the value of the wire length required to manufacture the coil with the value of a length of the wire W wound on the wire supply part 31.

### Advantageous Effects

As described above, the core winder according to the present disclosure has the effect of reducing material costs and energy by respectively tailoring required wire lengths according to pulses in manufacturing an electric motor coil.

In addition, the present disclosure has the effect of preventing the wire winder from being damaged by a cut wire, while still being easy to apply to existing machines.

Furthermore, the present disclosure has the effect of preventing work from being interrupted due to a lack of a wire supplied during the process of manufacturing the electric motor coil.

### BRIEF DESCRIPTION OF THE DRAWINGS

FIG. 1 is a front view of a coil winder according to the present disclosure.

FIG. 2 is a schematic diagram of the coil winder without a cutting cover installed according to the present disclosure.

FIG. 3 is a plan view of the coil winder installed with the cutting cover according to the present disclosure.

FIG. 4 is a front view of the cutting cover according to the present disclosure.

FIG. 5 is a schematic diagram showing positions of coils and lead wires installed in the stator slots.

FIG. 6 is a schematic diagram showing positions of connection of the lead wires of the coils installed in the stator slots.

<Description of the Reference Numerals in the Drawings>

| | |
|---|---|
| 10: Rotary table | 11: Insert tool |
| 12: Rotation motor | |
| 20: Winding framework part | 21: Winding spindle |
| 22: Winding guide | 23: Support part |
| 30: Flier part | 31: Wire supply part |
| 40: Gripping part | |
| 50: Cutting part | 51: Cutting member |
| 52: Cutting cover | |
| 53: Anti-reverse movement device | |
| 54: Elastic member | |
| 60: Controller | |
| 100: Coil winder | |
| W: Wire | |

### DETAIL DESCRIPTION OF THE EMBODIMENTS

Advantages and features of the present disclosure and methods of achievement thereof will become clear by referring to embodiments described in detail below along with the accompanying drawings. However, the present disclosure is not limited to the embodiments disclosed below and will be implemented in various forms different from each other. In addition, the embodiments are provided solely to ensure that the disclosure of the present disclosure is complete and to fully inform those skilled in the art of the present disclosure of a scope of the invention, and the present disclosure is defined only by the scope of the claims.

Specific details for implementing the present disclosure will be described in detail with reference to the drawings attached below. Regardless of the drawings, the same reference numerals refer to the same elements, and “and/or” includes each, and all combinations of at least one, of the mentioned items.

Terms used herein are for describing embodiments and are not intended to limit the invention. In the present specification, singular forms also include plural forms, unless specifically stated otherwise in the context. As used in the specification, “comprises” and/or “comprising” does not exclude the presence or addition of at least one of other elements in addition to the mentioned elements.

Unless otherwise defined, all terms (including technical and scientific terms) used in the present specification may be used with meanings that may be commonly understood by those skilled in the art to which the present disclosure pertains. Additionally, terms defined in commonly used dictionaries are not interpreted ideally or excessively unless clearly specifically defined.

Hereinafter, exemplary embodiments of the present disclosure will be described in detail with reference to the accompanying drawings.

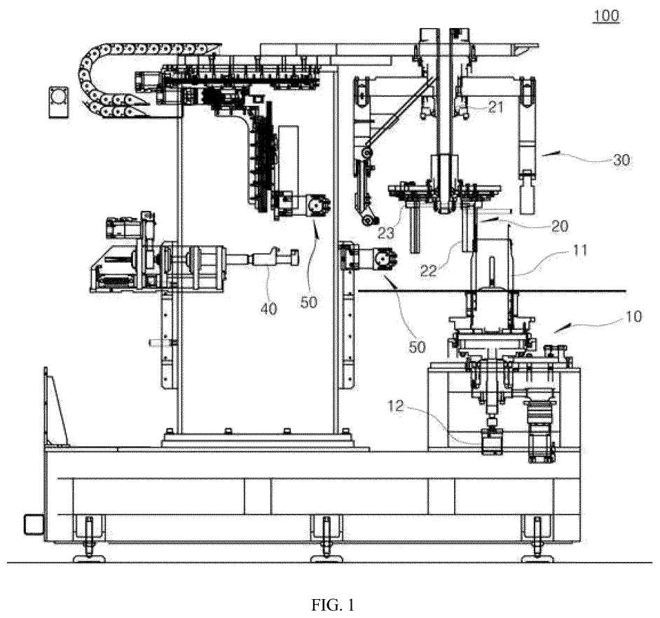

FIG. 1 is a front view of a coil winder according to the present disclosure.

As shown, the coil winder 100, configured to minimize a loss of the wire W necessary to manufacture a coil of an electric motor according to the present disclosure, includes: a rotary table 10 provided with an insert tool 11 on which the coil is to be stacked on an upper surface and a rotation motor 12 configured to rotate the insert tool 11; a winding framework part 20 provided with a winding cylinder 21, which is vertically provided above the rotary table 10, winding guides 22 installed at an end part of a rod of the winding cylinder 21 and around which the wire W is to be wound, and a support part 23 provided on the winding guides 22 and configured to slide up and down so that the coil is stacked on the insert tool 11; a flier part 30 installed on one side of the winding cylinder 21 and configured, while being rotated, to wind the wire W wound around the wire supply part 31 around the outer part of the winding guides 22; a gripping part 40 configured to hold one side of the wire W and pull and move the wire W to an outer side of the winding framework part 20 after the rotating operation of the flier 30; a cutting part 50 provided with a cutting member 51 configured to cut the wire W pulled by the gripping part 40 and a cutting cover 52 configured to protect the coil winder 100 by surrounding the wire W at a predetermined interval to prevent the wire W from popping up outwards when the wire W is cut; and although not shown, a controller 60 configured to control sequential operations of the coil winder 100 and the moving distance of the gripping part 40.

At this time, in the sequential operations of the coil winder 100, while maintaining a state in which the gripping part 40 holds the one side of the wire supplied from the wire supply part 31, the flier part 30 rotates and allows the wire to be wound to the outer perimeter of the winding guides 22. After the rotating operation is completed, the gripping part 40 sets free the part it first gripped and holds a part of an opposite side to pull to the outer side of the winding framework part 20. Then, the cutting member 51 cuts the wire W, which is pulled, at a designated position, and the coil wound on the winding framework part 20 is pushed by the support part 23 to be stacked on the insert tool 11. Here, the configuration of the coil winder 100 described above and the sequential operations of the coil winder 100 are mentioned in the conventional art and, at the same time, widely known technology, so a more detailed description will be omitted.

However, the cutting part 50 and the controller 60, which are featured in the coil winder 100 that minimizes the loss of the wire W necessary to manufacture the electric motor coil according to the exemplary embodiment of the present disclosure, will be described.

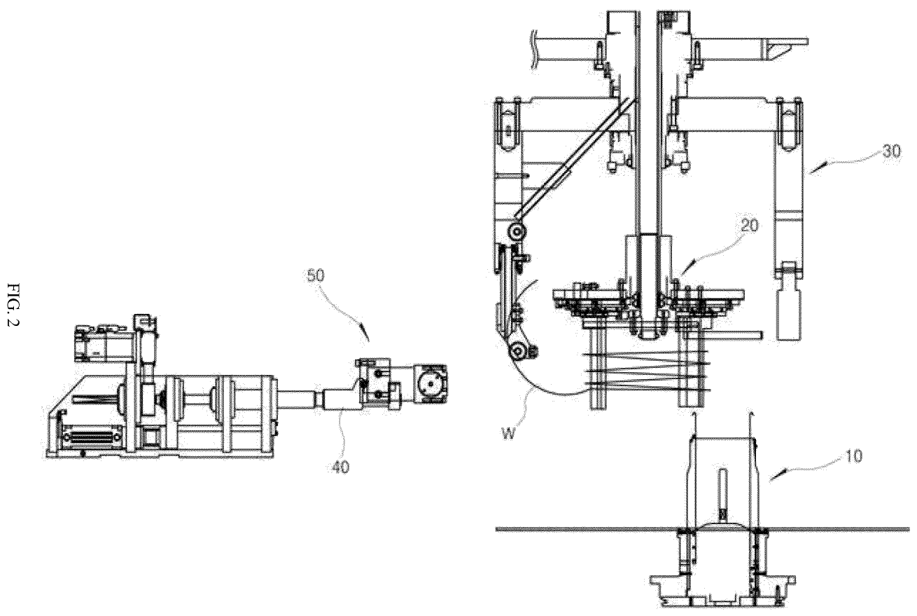

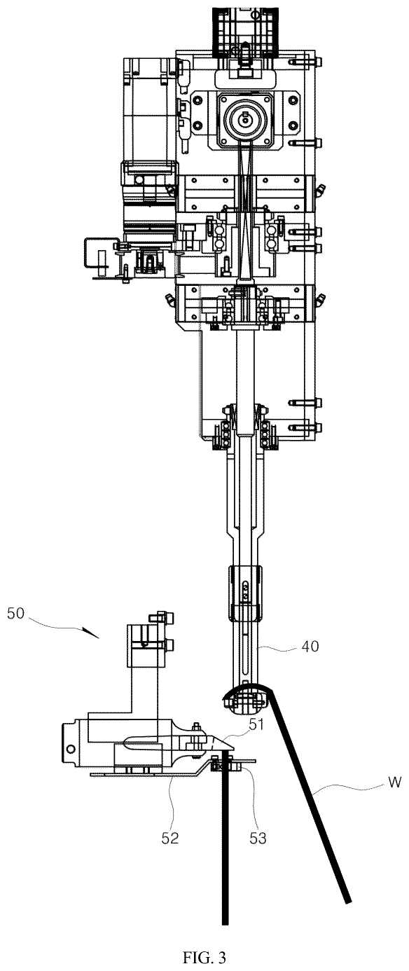

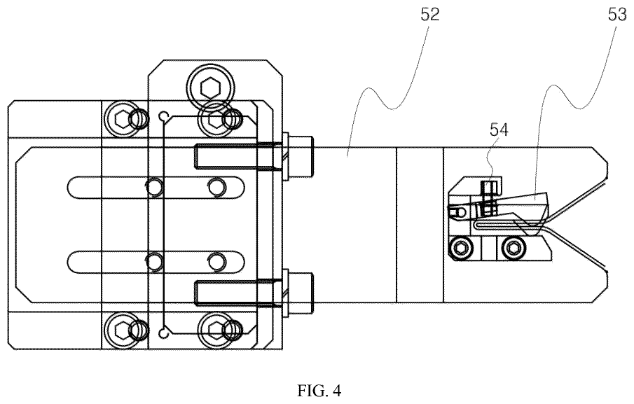

FIG. 2 is a schematic diagram of the coil winder without a cutting cover installed according to the present disclosure, FIG. 3 is a plan view of the coil winder installed with the cutting cover according to the present disclosure, and FIG. 4 is a front view of the cutting cover according to the present disclosure.

As shown, in the case of the conventional cutting part 50 that does not include the cutting cover 52, when cutting the wire pulled by the gripping part 40, a phenomenon occurs in that the wire W, which is not being held by the gripping part 40 based on the cutting surface, is popping up outwards by tension, causing the wire W to become entangled in the fliers 30 or caught in the insert tool 11, and a phenomenon occurs in that a part that becomes a lead wire of the coil is bent, causing defects. In order to solve such problems, the cutting part 50 of the present disclosure includes a cutting cover 52 that surrounds the wire W held by the gripping part 40 at a predetermined interval.

The cutting cover 52 is installed on one side of the cutting part 50 to be fixable and detachable through at least one fixing screw that vertically penetrates the cutting cover 52 and has an insertion groove provided on one side to be inserted perpendicular to the length direction of the wire W.

At this time, the insertion groove has surfaces each provided to be inclined to the center at a predetermined angle so that the wire W may be aligned by sliding toward the center, and an anti-reverse movement device 53 is installed to prevent the wire W positioned inside the insertion groove from moving in the direction of an opening of the insertion groove.

In addition, the anti-reverse movement device 53 includes a latch, which has an inclined surface provided on its outer side at a predetermined angle and may be pushed up by the wire W when the wire W is inserted, a latch support is provided at a lower part of the latch and supports the latch, so that the latch is prevented from sagging downward, and the latch pivots by being hinged to one side of the latch support.

In addition, the anti-reverse movement device 53 may have an elastic member 54 provided at an upper part of the latch, wherein the elastic member 54 supports the latch in the direction toward the latch support to maintain a closed state in which the latch remains in contact with the latch support and prevents the wire W that is cut inside the insertion groove from pushing the latch outwards.

Therefore, when the cutting part 50 cuts the wire W, the cutting cover 52 may cover the outer peripheral surface of the wire W to prevent the wire W from popping up outwards when the wire W is cut, thereby preventing damage to the coil winder 100.

Therefore, the cutting cover 52 is a simple configuration and has effects in preventing the multiple strands of the coil from being cut and popping up outwards and the coils from spreading or scattering.

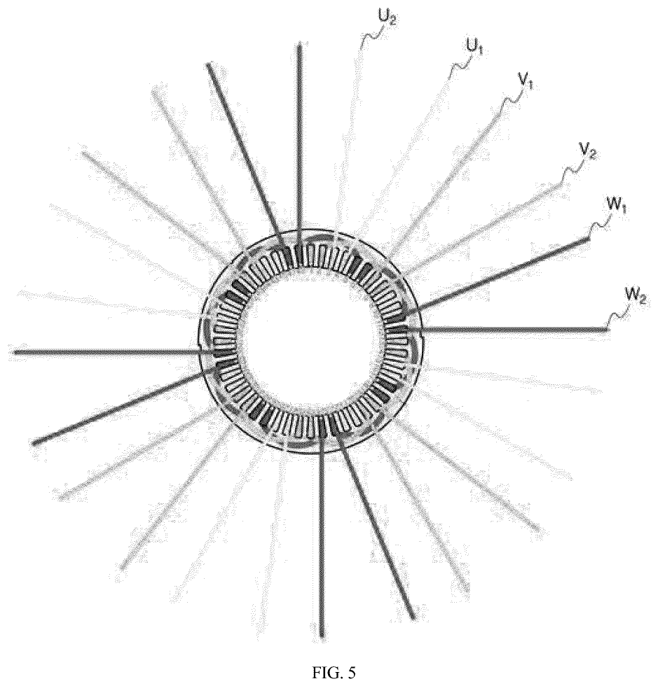

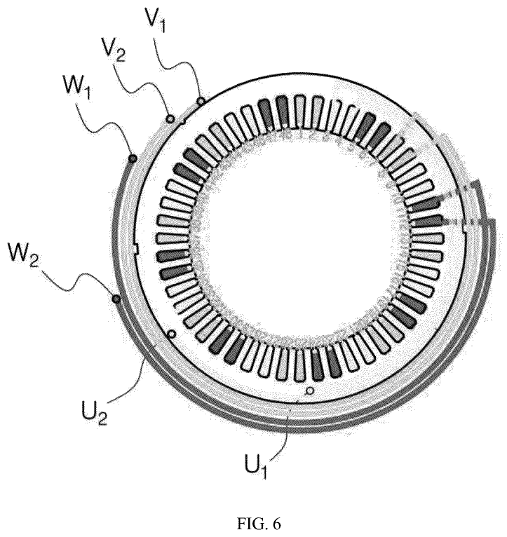

FIG. 5 is a schematic diagram showing positions of coils and lead wires installed in the stator slots, and FIG. 6 is a schematic diagram showing positions of connection of the lead wires of the coils installed in the stator slots.

As shown, the coil winder 100 of the present disclosure is a device configured to wind a coil inserted into a stator slot inside the electric motor, and the coil, including a pair of lead wires configured to receive and output power from and to the outside, respectively, is inserted into the slot. Here, the coils are inserted into 48 slots provided on the stator of the electric motor that uses three-pulse power, and the coils, which are composed of a shunt method so that the polarity of the motor has 8 poles, are divided into U-pulse, V-pulse, and W-pulse according to the pulse of the motor.

Here, a U-pulse first lead wire U1 is wound from slot 4 up to slot 24, a U-pulse second lead wire U2 is wound from slot 3 up to slot 32, a V-pulse first lead wire V1 is wound from slot 7 up to slot 44, and a V-pulse second lead wire V2 is wound from slot 8 up to slot 42. At this time, lead wires respectively constituting the three pulses are connected using the ends, of the aforementioned U-pulse, V-pulse, W-pulse, and lead wires as references, thereby being provided as output terminals.

At this time, the lead wire refers to the wire W that is not inserted into the slot and extended externally, after winding the coil.

In addition, U-pulse lead wires respectively extended from the 15th and 16th slots and wound up to the 24th and 32nd slots need wires shorter than the U-pulse first lead wire U1 extending from the 4th slot and the U-pulse second lead wire U2 extending from the 3rd slot, above-mentioned.

Additionally, by the same principle, it may be understood that the slot containing the U-pulse other lead wires may have different lead wire length than the slots containing V-pulse other lead wires and the W-pulse other lead wires may have.

As mentioned above, in manufacturing a motor coil, the length of each of the lead wires for coils of the same pulse varies depending on the number of poles of the motor. Therefore, when coils of the same pulse are manufactured with lead wires of the same length, the lead wires need to have different lengths to be arranged in one position when aligning the length of lead wires at the output terminal, so cutting wires occur.

At this time, the number of slots, the number of poles, the number indicating the position of the slot designated by the end of the lead wire of each pulse, and the arrangement order of each pulse are only examples to explain the necessity of the coil winder 100 of the present disclosure. In other words, these may naturally change depending on the type of electric motor produced, and the present disclosure is not limited to these.

Accordingly, the controller 60 of the coil winder 100 of the present disclosure is configured: to set the length of the lead wire extending from the slot provided inside the electric motor to the output terminal to control the movement distance of the gripping part 40; and to cut the wire at the gripping spot of the gripping part 40 to tailor the length of each lead wire according to the pulse of the electric motor to correspond to the type of electric motor being manufactured. As a result, this has the effect of reducing a loss of the wire W, the loss occurring while aligning lead wires at the output terminal.

In addition, the length of the lead wire set in the controller 60 may be calculated by including at least one variable among the circumference of the stator, the positions corresponding to the number of slots, the number of poles, the pulses, and the position of the output terminal, which are determined according to the type of electric motor being manufactured.

In addition, the controller 60 is configured: to control the cutting position of the cutting part 50 using the set length of the lead wire; and to cut the wire W between the part gripped by the gripping part 40 and the winding guide 22 to tailor the length of each lead wire according to the pulse of the motor to correspond to the type of motor being manufactured. As a result, this has the effect that the loss of the wire W may be reduced, the loss occurring while aligning lead wires at the output terminal.

Next, the controller 60 of the present disclosure is configured to determine whether the coil winder 100 is suitable for operation by comparing the value of the wire length required to manufacture the coil with the value of the length of the wire W wound on the wire supply unit 31.

In other words, when the amount of remaining wire W wound in the wire supply unit 31 is less than the amount of wire W for coil production set in the controller 60, the coil winder 100 of the present disclosure may not start the coil manufacturing process, thereby reducing coil defects caused by a lack of wire during the process. Meanwhile, users may review whether other types of electric motors may be manufactured utilizing the remaining amount, thereby improving production efficiency by setting the length of wire required for another process. As a result, this has the effect that the loss of the wire W may be reduced.

In addition, the length of the wire required to manufacture the coil to be set in the controller 60 may be calculated on the basis of at least one of the distance and circumference between the winding guides 22, the number of rotations of the flier unit 30, and the length of the lead wire described above.

Although the embodiments of the present disclosure have been described with reference to the above and the accompanying drawings, those skilled in the art will understand that the present disclosure may be implemented in other specific forms without changing the technical idea or essential features. Therefore, the embodiments described above should be understood in all respects as illustrative and not restrictive.

What is claimed is:

1. An electric motor coil winder that minimizes a loss of a wire required to manufacture a coil of an electric motor, comprising:
a rotary table provided with an insert tool on which the coil is to be stacked on an upper surface and a rotation motor configured to rotate the insert tool;
a winding framework part provided with a winding cylinder, which is vertically provided above the rotary table, winding guides installed at an end part of a rod of the winding cylinder and around which the wire is to be wound, and a support part provided on the winding guides and configured to slide up and down so that the coil is stacked on the insert tool;
a flier part configured to wind the wire, which is wound around a wire supply part, to the winding guides, while rotating along an outer part of the winding guides;
a gripping part configured to hold one side of the wire and pull and move the wire to an outside of the winding framework part after a rotating operation of the flier part;
a cutting part provided with a cutting member configured to cut the wire pulled by the gripping part and a cutting cover configured to protect the electric motor coil winder by surrounding the wire at a predetermined interval to prevent the wire from popping up outwards when the wire is cut; and
a controller configured to control sequential operations of the electric motor coil winder and a moving distance of the gripping part.

2. The electric motor coil winder of claim 1, wherein the cutting cover is provided with an insertion groove, in which inclined surfaces each having a predetermined angle are provided to allow the wire to be slid to a center to be aligned when the cutting part moves perpendicular to a length direction of the wire, and prevents the wire from popping up outwards when the wire is cut by including an anti-reverse movement device that is configured to prevent the wire positioned inside the insertion groove from moving outwards, thereby preventing damage to the electric motor coil winder.

3. The electric motor coil winder of claim 1, wherein the controller sets a length of a lead wire that is the wire extending from a slot provided inside the electric motor up to an output terminal but tailors a length of each lead wire according to a pulse of the electric motor, thereby reducing the loss of the wire that occurs while aligning the lead wire in the output terminal.

4. The electric motor coil winder of claim 1, wherein the controller is configured to determine whether the electric motor coil winder is suitable for operation by comparing a value of a wire length required to manufacture the coil with a value of a length of the wire wound on the wire supply part.
